(19) United States
(12) Patent Application Publication
(10) Pub. No.: US 2009/0004478 A1
(43) Pub. Date: Jan. 1, 2009

(54) FLEXIBLE HARDCOAT COMPOSITIONS, ARTICLES, AND METHODS

(75) Inventors: JOHN P. BAETZOLD, North St. Paul, MN (US); Richard J. Pokorny, Maplewood, MN (US); Richard L. Severance, Stillwater, MN (US); Stephen A. Johnson, Woodbury, MN (US); Steven J. McMan, Stillwater, MN (US); John J. Stradinger, Roseville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/137,074

(22) Filed: Jun. 11, 2008

Related U.S. Application Data
(63) Continuation-in-part of application No. 11/771,705, filed on Jun. 29, 2007.
(60) Provisional application No. 61/015,920, filed on Dec. 21, 2007.

(51) Int. Cl. B32B 27/40; C08G 18/06; B28B 19/00

(52) U.S. Cl. 428/412; 528/75; 524/589; 264/269; 428/424.4

(57) ABSTRACT

Flexible hardcoat compositions and protective films are described comprising the reaction product one or more urethane (meth)acrylate oligomers; at least one monomer comprising at least three (meth)acrylate groups; and optionally inorganic nanoparticles. The cured hardcoat composition is preferably sufficiently flexible such that a 5 micron film can be bent around a 2 mm mandrel without cracking.

### RELATED APPLICATIONS

This application claims priority to U.S. Patent Application Ser. No. 61/015,920 filed Dec. 21, 2007 and is a continuation-in-part of U.S. patent application Ser. No. 11/771,705 filed Jun. 29, 2007.

### BACKGROUND

Hardcoats have been used to protect the face of optical displays. Durable hardcoats typically contain inorganic oxide particles, e.g., silica, of nanometer dimensions dispersed in a binder precursor resin matrix, and sometimes are referred to as “ceramers”. The binder precursor resin may comprise a urethane (meth)acrylate material. See for example U.S. Pat. No. 7,070,849; US2005/0221095; and US2006/0147729.

### SUMMARY

Although various hardcoat compositions have been described, industry would find advantage in hardcoat compositions having improved flexibility.

In one embodiment a protective film is described comprising a cured hardcoat. The hardcoat comprises the reaction product of one or more urethane (meth)acrylate oligomers; at least one monomer comprising at least three (meth)acrylate groups; and optionally inorganic nanoparticles. The cured hardcoat composition is sufficiently flexible such that a 5 micron film can be bent around a 2 mm mandrel without cracking.

In one aspect, the protective film comprises the cured hardcoat composition disposed on a light transmissive film substrate. In another aspect, the protective film comprises the cured hardcoat composition disposed on a release liner.

In another embodiment, a flexible hardcoat coating composition is described comprising one or more urethane di-(meth)acrylate oligomers; at least one monomer comprising at least three (meth)acrylate groups; and optionally inorganic nanoparticles; wherein the composition comprises less than 40 wt-% of crosslinkers comprising more that four (meth)acrylate groups.

### BRIEF DESCRIPTION OF THE DRAWINGS

FIG. 1 is a schematic diagram of a hardcoat film article of the invention.

FIG. 2 is a schematic diagram of a hardcoat film article of the invention comprising a (e.g. thermoplastic) light transmissive film layer.

FIG. 3 is a schematic diagram of a hardcoat film article of the invention comprising an adhesive layer and an optional second release liner.

### DETAILED DESCRIPTION OF THE PREFERRED EMBODIMENTS

Presently described are hardcoat compositions formed from the reaction product of a polymerizable composition comprising one or more urethane (meth)acrylate oligomer(s). Typically, the urethane (meth)acrylate oligomer is a di(meth)acrylate. The term “(meth)acrylate” is used to designate esters of acrylic and methacrylic acids, and “di(meth)acrylate” designates a molecule containing two (meth)acrylate groups.

Oligomeric urethane (meth)acrylates may be obtained commercially; e.g., from Sartomer under the trade “CN 900 Series”, such as “CN981” and “CN981B88. Oligomeric urethane (meth)acrylates are also available from Cytek and Cognis. Oligomeric urethane (meth)acrylates may also be prepared by the initial reaction of an alkylene or aromatic diisocyanate of the formula OCN—R—NCO with a polyol. Most often, the polyol is a diol of the formula HO—R⁴—OH, wherein R³ is a C₂₋₁₀₀ alkylene or an arylene group and R⁴ is a C₂₋₁₀₀ alkylene or alkoxy group. The intermediate product is then a urethane diol diisocyanate, which subsequently can undergo reaction with a hydroxyalkyl (meth)acrylate. Suitable diisocyanates include alkylene diisocyanates such as 2,2,4-trimethylhexylene diisocyanate. The urethane (meth)acrylate oligomer employed herein is preferably aliphatic.

The urethane (meth)acrylate oligomer contributes to the conformability and flexibility of the cured hardcoat composition. In preferred embodiments, a 5 micron thick film of the cured hardcoat composition is sufficiently flexible such that it can be bent around a 2 mm mandrel without cracking.

In addition to being flexible, the hardcoat has good durability and abrasion resistance. For example, a 5 mil thick film of the cured hardcoat exhibits a change in haze of less than 10% after the oscillating sand abrasion testing (tested as described in the forthcoming example).

The kind and amount of urethane (meth)acrylate oligomer is selected in order to obtain a synergistic balance of flexibility and good abrasion resistance.

One suitable urethane (meth)acrylate oligomer that can be employed in the hardcoat composition is available from Sartomer Company (Exton, Pa.) under the trade designation “CN981B88”. This particular material is an aliphatic urethane (meth)acrylate oligomer available from Sartomer Company under the trade designation CN981 blended with SR238 (1,6 hexanediol diacrylate). Other suitable urethane (meth)acrylate oligomers are available from Sartomer Company under the trade designations “CN9001” and “CN991”. The physical properties of these aliphatic urethane (meth)acrylate oligomers, as reported by the supplier, are set forth as follows:

| | | | | Tg (° C.) as |
|---|---|---|---|---|
| Trade | Viscosity | Tensile | | determined |
| Designation | Cps at 60° C. | Strength psi | Elongation | by DSC |
| CN981 | 6190 | 1113 | 81 | 22 |
| CN981B88 | 1520 | 1520 | 41 | 28 |
| CN9001 | 46,500 | 3295 | 143 | 60 |
| CN991 | 660 | 5,378 | 79 | 27 |

The reported tensile strength, elongation, and glass transition temperature (Tg) properties are based on a homopolymer prepared from such urethane (meth)acrylate oligomer. These embodied urethane (meth)acrylate oligomers can be characterized as having an elongation of at least 20% and typically no greater than 200%; a Tg ranging from about 0 to 70° C.; and a tensile strength of at least 1,000 psi, or at least 5,000 psi.

These embodied urethane (meth)acrylate oligomers and other urethane (meth)acrylate oligomers having similar physical properties can usefully be employed at concentrations ranging from at least 25 wt-%, 26 wt-%, 27 wt-%, 28 wt-%, 29 wt-%, or 30 wt-% based on wt-% solids of the hardcoat composition. When the hardcoat composition further comprises inorganic nanoparticles such as silica, the total concentration of the urethane (meth)acrylate oligomer is typically higher, ranging from about 40 wt-% to about 75 wt-%. The concentration of urethane (meth)acrylate oligomer can be adjusted based on the physical properties of the urethane (meth)acrylate oligomer selected.

The urethane (meth)acrylate oligomer is combined with at least one multi(meth)acrylate monomer comprising three or four (meth)acrylate groups. The multi(meth)acrylate monomer increases the crosslinking density and thereby predominantly contributes the durability and abrasion resistance to the cured hardcoat.

Suitable tri(meth)acryl containing compounds include glycerol triacrylate, trimethylolpropane triacrylate, ethoxylated triacrylates (for example, ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (for example, propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, pentaerythritol triacrylate, and tris(2-hydroxyethyl)isocyanurate triacrylate.

Higher functionality (meth)acryl containing compounds include ditrimethylolpropane tetraacrylate, ethoxylated (4) pentaerythritol tetraacrylate, and pentaerythritol tetraacrylate.

Commercially available cross-linkable acrylate monomers include those available from Sartomer Company, Exton, Pa. such as trimethylolpropane triacrylate available under the trade designation SR351, pentaerythritol triacrylate available under the trade designation SR444, dipentaerythritol triacrylate available under the trade designation SR399LV, ethoxylated (3) trimethylolpropane triacrylate available under the trade designation SR454, ethoxylated (4) pentaerythritol triacrylate, available under the trade designation SR494, and tris(2-hydroxyethyl)isocyanurate triacrylate, available under the trade designation SR368.

The hardcoat may additionally comprise one or more di(meth)acryl containing compounds. For example, the urethane (meth)acrylate oligomer may be purchased preblended with a di(meth)acrylate monomer such as in the case of CN988B88”. Suitable monomers include for example 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, and tripropylene glycol diacrylate.

It has been found that when substantial concentrations of (meth)acrylate monomer having greater than four (meth)acrylate groups are employed, the flexibility of the hardcoat is reduced. Hence, when such monomers are employed, the concentration is typically less than 40 wt-%, 30 wt-%, 20 wt-%, 10 wt-%, 5 wt-%, or 3 wt-% solids of the total hardcoat composition. In some embodiments, the hardcoat composition is free of monomers comprising more than four (meth)acrylate groups.

The hardcoat may optionally comprise one or more other oligomeric (meth)acryl compounds including polyester (meth)acrylates, epoxy (meth)acrylates and combinations thereof.

The hardcoat may optionally comprise at least one fluorine-containing or at least one silicone-containing (e.g. copolymerizable) component to lower the surface energy of the hardcoat. The surface energy can be characterized by various methods such as contact angle and ink repellency. Preferably, the surface layer exhibits a static contact angle with water of at least 80 degrees. More preferably, the contact angle is at least about 90 degrees. Alternatively, or in addition thereto, the advancing contact angle with hexadecane is at least 50 degrees. Low surface energy results in anti-soiling and stain repellent properties as well as rendering the exposed surface easy to clean.

One preferred fluorine-containing additive is an additive having a perfluoropolyether moiety and at least one free-radically polymerizable group.

In one embodiment, the perfluoropolyether urethane additive has the formula:

Rᵢ—(NHC(O)XQR_{f})ₘ, —(NHC(O)OQ(A)ₚ)ₙ; (Formula 1)

wherein
Rᵢ is the residue of a multi-isocyanate;
X is O, S or NR, wherein R is H or an alkyl group having 1 to 4 carbon;
R_{f} is a monovalent perfluoropolyether moiety comprising groups of the formula F(R_{fc}O)ₓC_{d}F_{2d-}, wherein each R_{fc} is independently a fluorinated alkylene group having from 1 to 6 carbon atoms, each x is an integer greater than or equal to 2, and wherein d is an integer from 1 to 6;
each Q is independently a connecting group having a valency of at least 2;
A is a (meth)acryl functional group —XC(O)C(R₂)═CH₂ wherein R₂ is an alkyl group of 1 to 4 carbon atoms or H or F;
m is at least 1; n is at least 1; p is 2 to 6; m+n is 2 to 10; wherein each group having subscripts m and n is attached to the Rᵢ unit.

Q in association with the Rf group is a straight chain, branched chain, or cycle-containing connecting group. Q can include an alkylene, an arylene, an aralkylene, an alkarylene. Q can optionally include heteroatoms such as O, N, and S, and combinations thereof. Q can also optionally include a heteroatom-containing functional group such as carbonyl or sulfonyl, and combinations thereof.

When X is O, Q is typically not methylene and thus contains two or more carbon atoms. In some embodiments, X is S or NR. In some embodiments, Q is an alkylene having at least two carbon atoms. In other embodiments, Q is a straight chain, branched chain, or cycle-containing connecting group selected from arylene, aralkylene, and alkarylene. In yet other embodiments, Q contains a heteroatom such as O, N, and S and/or a heteroatom containing functional groups such as carbonyl and sulfonyl. In other embodiments, Q is a branched or cycle-containing alkylene group that optionally contains heteroatoms selected from O, N, S and/or a heteroatom-containing functional group such as carbonyl and sulfonyl. In some embodiments Q contains a nitrogen containing group such an amide group such as —C(O)NHCH₂CH₂—, —C(O)NH(CH₂)₆—, and —C(O)NH(CH₂CH₂O)₂CH₂CH₂—.

If the mole fraction of isocyanate groups is given a value of 1.0, then the total mole fraction of m and n units used in making materials of Formula (1) is 1.0 or greater. The mole fractions of m:n ranges from 0.95:0.05 to 0.05:0.95. Preferably, the mole fractions of m:n are from 0.50:0.50 to 0.05:0.95. More preferably, the mole fractions of m:n are from 0.25:0.75 to 0.05:0.95 and most preferably, the mole fractions of m:n are from 0.25:0.75 to 0.10:0.95. In the instances the mole fractions of m:n total more than one, such as 0.15:0.90, the m unit is reacted onto the isocyanate first, and a slight excess (0.05 mole fraction) of the n units are used.

In a formulation in which 0.15 mole fractions of m and 0.85 mole fraction of n units are introduced, a distribution of products is formed in which some fraction of products formed contain no m units. There will, however, be present in this product distribution, materials of Formula (1).

One representative reaction product formed by the reaction product of a biuret of HDI with one equivalent of HFPO oligomer amidol HFPO—C(O)NHCH₂CH₂OH with two equivalents of pentaerythritol triacrylate is shown as follows

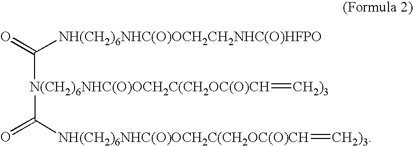

Unless otherwise noted, “HFPO—” refers to the end group F(CF(CF₃)CF₂O)aCF(CF₃)— of the methyl ester F(CF(CF₃)CF₂O)aCF(CF₃)C(O)OCH3, wherein “a” averages at least 2, 3, 4 or 5 and is typically no greater than 15, 10, or 8. Such species generally exist as a distribution or mixture of oligomers with a range of values for “a”, so that the average value of “a” may be a non-integer.

Various other reactants can be included in the preparation of the perfluoropolyether urethane such as described in WO2006/102383 and U.S. Patent Publication No. 2008/0124555, entitled “Polymerizable Composition Comprising Perfluoropolyether Urethane Having Ethylene Oxide Repeat Units”; incorporated herein by reference in its entirety.

In some embodiments, the polymerizable hardcoat composition or an underlying hardcoat layer preferably contain (e.g. surface modified) inorganic particles that add mechanical strength and durability to the resultant coating. The inorganic nanoparticles can include, for example, silica, alumina, or zirconia (the term “zirconia” includes zirconia metal oxide) nanoparticles. In some embodiments, the nanoparticles have a mean diameter in a range from 1 to 200 nm, or 5 to 150 nm, or 5 to 125 nm. Nanoparticles can be present in an amount from 10 to 200 parts per 100 parts of hardcoat layer monomer.

Useful silica nanoparticles are commercially available from Nalco Chemical Co. (Naperville, Ill.) under the product designation NALCO COLLOIDAL SILICAS. For example, silicas include NALCO products 1040, 1042, 1050, 1060, 2327 and 2329. Useful zirconia nanoparticles are commercially available from Nalco Chemical Co. (Naperville, Ill.) under the product designation NALCO OOSSOO8.

Various high refractive index inorganic oxide particles can be employed such as for example zirconia (“ZrO₂”), titania (“TiO₂”), antimony oxides, alumina, tin oxides, alone or in combination. Mixed metal oxide may also be employed. Zirconias for use in the high refractive index layer are available from Nalco Chemical Co. under the trade designation “Nalco OOSSOO8” and from Buhler AG Uzwil, Switzerland under the trade designation “Buhler zirconia Z-WO sol”. Zirconia nanoparticle can also be prepared such as described in U.S. Pat. Nos. 7,241,437 and 6,376,590.

Surface treating or surface modification of the nanoparticles can provide a stable dispersion in the hardcoat layer resin. The surface-treatment can stabilize the nanoparticles so that the particles will be well dispersed in the polymerizable resin and result in a substantially homogeneous composition. Furthermore, the nanoparticles can be modified over at least a portion of its surface with a surface treatment agent so that the stabilized particle can copolymerize or react with the polymerizable hardcoat layer resin during curing.

The nanoparticles can be treated with a surface treatment agent. In general a surface treatment agent has a first end that will attach to the particle surface (covalently, ionically or through strong physisorption) and a second end that imparts compatibility of the particle with the hardcoat layer resin and/or reacts with hardcoat layer resin during curing. Examples of surface treatment agents include alcohols, amines, carboxylic acids, sulfonic acids, phosphohonic acids, silanes and titanates. The preferred type of treatment agent is determined, in part, by the chemical nature of the inorganic particle or metal oxide particle surface. Silanes are generally preferred for silica and zirconia. The surface modification can be done either subsequent to mixing with the monomers or after mixing.

In some embodiments, it is preferred to react silanes with the particle or nanoparticle surface before incorporation into the resin. The required amount of surface modifier is dependant upon several factors such as particle size, particle type, modifier molecular wt, and modifier type. In general it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for approximately 1-24 hours approximately. Surface treatment agents such as carboxylic acids do not require elevated temperatures or extended time.

Surface modification of zirconia with silanes can be accomplished under acidic conditions or basic conditions. In one embodiment, silanes are preferably heated under acid conditions for a suitable period of time at which time the dispersion is combined with aqueous ammonia (or other base). This method allows removal of the acid counter ion from the ZrO₂ surface as well as reaction with the silane. Then the particles are precipitated from the dispersion and separated from the liquid phase.

The surface modified nanoparticles can be incorporated into the curable resin by various methods. In one embodiment, a solvent exchange procedure is utilized whereby the resin is added to the surface modified nanoparticles, followed by removal of the water and co-solvent (if used) via evaporation, thus leaving the nanoparticles dispersed in the polymerizable resin. The evaporation step can be accomplished for example, via distillation, rotary evaporation or oven drying, as desired.

Representative examples of surface treatment agents suitable for inclusion in the hardcoat layer include compounds such as, for example, phenyltrimethoxysilane, phenyltriethoxysilane, 2-(3,4-epoxycyclohexyl)ethyltriethoxysilane, 2-(3,4-epoxycyclohexyl)ethyltrimethoxysilane, isooctyl trimethoxy-silane, N-(3-triethoxysilylpropyl) methoxyethoxyethoxyethyl carbamate (PEG3TES), Silquest A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof.

A photoinitiator can be included in the hardcoat layer. Examples of initiators include chlorotriazines, benzoin, benzoin alkyl ethers, di-ketones, phenones, and the like. Commercially available photoinitiators include those available commercially from Ciba Geigy under the trade designations Daracur™ 1173, Darocur™ 4265, Irgacure™ 651, Irgacure™ 184, Irgacure™ 1800, Irgacure™ 369, Irgacure™ 1700, Irgacure™ 907, Irgacure™ 819 and from Aceto Corp. (Lake Success, N.Y.) under the trade designations UVI-6976 and UVI-6992. Phenyl-[p-(2-hydroxytetradecyloxy)phenyl]iodonium hexafluoroantomonate is a photoinitiator commercially available from Gelest (Tullytown, Pa.). Phosphine oxide derivatives include Lucirin™ TPO, which is 2,4,6-trimethylbenzoy diphenyl phosphine oxide, available from BASF (Charlotte, N.C.). In addition, further useful photoinitiators are described in U.S. Pat. Nos. 4,250,311, 3,708,296, 4,069,055, 4,216,288, 5,084,586, 5,124,417, 5,554,664, and 5,672,637. A photoinitiator can be used at a concentration of about 0.1 to 10 weight percent or about 0.1 to 5 weight percent based on the organic portion of the formulation (phr).

The hardcoat layer can be cured in an inert atmosphere. Curing the hardcoat layer in an inert atmosphere can assist in providing/maintaining the scratch and stain resistance properties of the hardcoat layer. In some embodiments, the hardcoat layer can be cured with an ultraviolet (UV) light source under a nitrogen blanket.

To enhance durability of the hardcoat layer, especially in outdoor environments exposed to sunlight, a variety of commercially available stabilizing chemicals can be added. These stabilizers can be grouped into the following categories: heat stabilizers, UV light stabilizers, and free-radical scavengers. Heat stabilizers can typically be present in amounts ranging from 0.02 to 0.15 weight percent. UV light stabilizers can be present in amounts ranging from 0.1 to 5 weight percent. Benzophenone type UV-absorbers are commercially available, for example, from Cytec Industries (West Patterson, N.J.) under the trade designation Cyasorb™ UV-1164, and Ciba Specialty Chemicals (Tarrytown, N.Y.) under the trade designations Tinuvin™ 900, Tinuvin™ 123 and Tinuvin™ 1130. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation Tinuvin™ 292 and Cytec Industries under the trade designation Cyasorb™ UV-3581.

The method of forming the hardcoated article or hardcoat protective film includes providing a (e.g. light transmissible) substrate layer and providing the composition on the (optionally primed) substrate layer. The coating composition is dried to remove the solvent and then cured for example by exposure to ultraviolet radiation (e.g. using an H-bulb or other lamp) at a desired wavelength, preferably in an inert atmosphere (less than 50 parts per million oxygen) or an electron beam. Alternatively, a transferable hardcoat film may be formed coating the composition to a release liner, at least partially cured, and subsequently transferring from the release layer to the substrate using a thermal transfer or photoradiation application technique.

The hardcoat composition can be applied as a single or multiple layers directly to an article or (e.g. light transmissive) film substrate using conventional film application techniques. Alternatively, the hardcoat may be applied to a release liner, at least partially cured, and transfer coated using a thermal transfer or a photoradiation application technique. Although it is usually convenient for the substrate to be in the form of a roll of continuous web, the coatings may be applied to individual sheets.

Thin films can be applied using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature such as by Edward Cohen and Edgar Gutoff, Modern Coating and Drying Technology, VCH Publishers, NY 1992, ISBN 3-527-28246-7 and Gutoff and Cohen, Coating and Drying Defects: Troubleshooting Operating Problems, Wiley Interscience, NY ISBN 0-471-59810-0.

Preferably the compositions of the invention are photopolymerizable. A variety of photoinitiators can be employed to facilitate photopolymerization. When crosslinking using UV radiation, light having a wavelength between about 360-440 nm is preferred, with light having a wavelength of about 395-440 nm being most preferred. A variety of UV light sources can be employed. Representative sources include but are not limited to a FUSION™ H-bulb high-intensity mercury lamp (which emits three bands centered at 254, 313, 365 nm and is commercially available from Fusion UV Systems, Inc.), a FUSION D-bulb iron-doped mercury lamp (which adds emission at 380-400 nm but which may emit less at lower wavelengths, and is commercially available from Fusion UV Systems, Inc.) and a FUSION V-bulb gallium-doped mercury lamp (which adds emission at 404-415 nm but which may emit less at lower wavelengths, and is commercially available from Fusion UV Systems, Inc.). In general, lower wavelengths promote surface cure and higher wavelengths promote bulk cure. A FUSION D-bulb generally represents a desirable overall compromise. Curing can take place under a suitable atmosphere, e.g., a nitrogen atmosphere to provide an inert environment for curing.

In some embodiments, the flexible hardcoat described herein is thermoformable after curing.

The (e.g. protective film) article having the hardcoat surface layer described herein may have a gloss or matte surface. Matte films typically have lower transmission and higher haze values than typical gloss films. For examples the haze is generally at least 5%, 6%, 7%, 8%, 9%, or 10% as measured according to ASTM D1003. Whereas gloss surfaces typically have a gloss of at least 130 as measured according to ASTM D 2457-03 at 60°; matte surfaces have a gloss of less than 120. One exemplary matte film is commercially available from U.S.A. Kimoto Tech of Cedartown, Ga., under the trade designation “N4D2A.”

The surface can be roughened or textured to provide a matte surface. This can be accomplished in a variety of ways as known in the art including embossing the surface with a suitable tool that has been bead-blasted or otherwise roughened, as well as by curing the composition against a suitable roughened master as described in U.S. Pat. Nos. 5,175,030 (Lu et al.) and 5,183,597 (Lu).

A particulate matting agent can be incorporated into the polymerizable composition in order to impart anti-glare properties to the surface layer. The amount of particulate matting agent added is between about 0.5 and 10% of the total solids of the composition, depending upon the thickness of the layer, with a preferred amount around 2%. The average particle diameter of the particulate matting agent has a predefined minimum and maximum that is partially dependent upon the thickness of the layer. However, generally speaking, average particle diameters below 1.0 microns do not provide the degree of anti-glare sufficient to warrant inclusion, while average particle diameters exceeding 10.0 microns deteriorate the sharpness of the transmission image. The average particle size is thus preferably between about 1.0 and 10.0 microns, and more preferably between 1.7 and 3.5 microns, in terms of the number-averaged value measured by the Coulter method.

As the particulate matting agent, inorganic particles or resin particles are used including, for example, amorphous silica particles, TiO₂ particles, Al₂O₃ particles, cross-linked polymer particles such as those made of cross-linked poly(methyl methacrylate), cross-linked polystyrene particles, melamine resin particles, benzoguanamine resin particles, and cross-linked polysiloxane particles. By taking into account the dispersion stability and sedimentation stability of the particles in the coating mixture for the anti-glare layer and/or the hard coat layer during the manufacturing process, resin particles are more preferred, and in particular cross-linked polystyrene particles are preferably used since such resin particles have a high affinity for the binder material and a small specific gravity.

As for the shape of the particulate matting agent, spherical and amorphous particles can be used. However, to obtain a consistent anti-glare property, spherical particles are desirable. Two or more kinds of particulate materials may also be used in combination.

One commercially available silica particulate matting agent having an average particle size of 3.5 microns is commercially available from W.R. Grace and Co., Columbia, Md. under the trade designation “Syloid C803”.

The attraction of the hardcoat surface to lint can be further reduced by including an antistatic agent. For example, an antistatic coating can be applied to the (e.g. optionally primed) substrate prior to coating the hardcoat. The thickness of the antistatic layer is typically at least 20 nm and generally no greater than 400 nm, 300 nm, or to 200 nm.

The antistatic coating may comprise at least one conductive polymer as an antistatic agent. Various conductive polymers are known. Examples of useful conductive polymers include polyaniline and derivatives thereof, polypyrrole, and polythiophene and its derivatives. One particularly suitable polymer is poly(ethylenedioxythiophene) (PEDOT) such as poly(ethylenedioxythiophene) doped with poly(styrenesulfonic acid) (PEDOT:PSS) commercially available from H.C. Starck, Newton, Mass. under the trade designation “BAYTRON P”. This conductive polymer can be added at low concentrations to sulfopolyester dispersions to provide antistatic compositions that provided good antistatic performance in combination with good adhesion particularly to polyester and cellulose acetate substrates.

In other embodiments, the antistatic coating or hardcoat composition may comprise conductive metal-containing particles, such as metals or semiconductive metal oxides. Such particles may also be described as nanoparticles having a particle size or associated particle size of greater than 1 nm and less than 200 nm. Various granular, nominally spherical, fine particles of crystalline semiconductive metal oxides are known. Such conductive particles are generally binary metal oxides doped with appropriate donor heteroatoms or containing oxygen deficiencies. Preferred doped conductive metal oxide granular particles include Sb-doped tin oxide, Al-doped zinc oxide, In-doped zinc oxide, and Sb-doped zinc oxide.

Various antistatic particles are commercially available as water-based and solvent-based dispersions. Antimony tin oxide (ATO) nanoparticle dispersions that can be used include a dispersion available from Air Products under the trade designation “Nano ATO S44A” (25 wt-% solids, water), 30 nm and 100 nm (20 wt-% solids, water) dispersions available from Advanced Nano Products Co. Ltd. (ANP), 30 nm and 100 nm ATO IPA sols (30 wt-%) also available from ANP, a dispersion available from Keeling & Walker Ltd under the trade designation “CPM10C” (19.1 wt-% solids), and a dispersion commercially available from Ishihara Sangyo Kaisha, Ltd under the trade designation “SN-100 D” (20 wt-% solids). Further, an antimony zinc oxide (AZO) IPA sol (20 nm, 20.8 wt-% solids) is available from Nissan Chemical America, Houston Tex. under the trade designations “CELNAX CX-Z210IP”, “CELNAX CX-Z300H” (in water), “CELNAX CX-Z401M” (in methanol), and “CELNAX CX-Z653M-F” (in methanol).

For nanoparticle antistats, the antistatic agent is present in an amount of at least 20 wt-%. For conducting inorganic oxide nanoparticles, levels can be up to 80 wt % solids for refractive index modification. When a conductive polymer antistat is employed, it is generally preferred to employ as little as possible due to the strong absorption of the conductive polymer in the visible region. Accordingly, the concentration is generally no greater than 20 wt-% solid, and preferably less than 15 wt-%. In some embodiments the amount of conductive polymer ranges from 2 wt-% to 5 wt-% solids of the dried antistatic layer.

In some embodiments, the protective film also provides antireflective properties. For example, when the hardcoat comprises a sufficient amount of high refractive index nanoparticles, the hardcoat can be suitable as the high refractive index layer of an antireflective film. A low index surface layer is then applied to the high refractive index layer. Alternatively, a high and low index layer may be applied to the hardcoat such as described in U.S. Pat. No. 7,267,850.

A variety of substrates can be utilized in the articles of the invention. Suitable substrate materials include glass as well as thermosetting or thermoplastic polymers such as polycarbonate, poly(meth)acrylate (e.g., polymethyl methacrylate or “PMMA”), polyolefins (e.g., polypropylene or “PP”), polyurethane, polyesters (e.g., polyethylene terephthalate or “PET”), polyamides, polyimides, phenolic resins, cellulose diacetate, cellulose triacetate, polystyrene, styrene-acrylonitrile copolymers, epoxies, and the like. Typically the substrate will be chosen based in part on the desired optical and mechanical properties for the intended use. Such mechanical properties typically will include flexibility, dimensional stability and impact resistance. The substrate thickness typically also will depend on the intended use. For most applications, a substrate thickness of less than about 0.5 mm is preferred, and is more preferably about 0.02 to about 0.2 mm. Self-supporting polymeric films are preferred. Films made from polyesters such as PET or polyolefins such as PP (polypropylene), PE (polyethylene) and PVC (polyvinyl chloride) are particularly preferred. The polymeric material can be formed into a film using conventional filmmaking techniques such as by extrusion and optional uniaxial or biaxial orientation of the extruded film. The substrate can be treated to improve adhesion between the substrate and the hardcoat layer, e.g., chemical treatment, corona treatment such as air or nitrogen corona, plasma, flame, or actinic radiation. If desired, an optional tie layer or primer can be applied to the substrate and/or hardcoat layer to increase the interlayer adhesion.

Various light transmissive optical films are known including but not limited to, multilayer optical films, microstructured films such as retroreflective sheeting and brightness enhancing films, (e.g. reflective or absorbing) polarizing films, diffusive films, as well as (e.g. biaxial) retarder films and compensator films.

Multilayer optical films provide desirable transmission and/or reflection properties at least partially by an arrangement of microlayers of differing refractive index. The microlayers have different refractive index characteristics so that some light is reflected at interfaces between adjacent microlayers. The microlayers are sufficiently thin so that light reflected at a plurality of the interfaces undergoes constructive or destructive interference in order to give the film body the desired reflective or transmissive properties. For optical films designed to reflect light at ultraviolet, visible, or near-infrared wavelengths, each microlayer generally has an optical thickness (i.e., a physical thickness multiplied by refractive index) of less than about 1 μm. Such films that reflect all visible light have a silver appearance and are often referred to as (e.g. colored) mirror films. However, thicker layers can also be included, such as skin layers at the outer surfaces of the film, or protective boundary layers disposed within the film that separate packets of microlayers. Multilayer optical film bodies can also comprise one or more thick adhesive layers to bond two or more sheets of multilayer optical film in a laminate.

Further details of suitable multilayer optical films and related constructions can be found in U.S. Pat. No. 5,882,774 (Jonza et al.), and PCT Publications WO 95/17303 (Ouderkirk et al.) and WO 99/39224 (Ouderkirk et al.). Polymeric multilayer optical films and film bodies can comprise additional layers and coatings selected for their optical, mechanical, and/or chemical properties such as described in U.S. Pat. No. 6,368,699 (Gilbert et al.). The polymeric films and film bodies can also comprise inorganic layers, such as metal or metal oxide coatings or layers.

Commercially available multilayer optical films include 3M™Vikuiti™Dual Brightness Enhancement Film and 3M™Vikuiti™ Enhanced Specular Reflector Film.

In some embodiments, the conformable hardcoat is applied to a substrate having at least one metallic or organometallic layer. Such substrate may be employed for the purpose of providing a decorative metallic finish and/or for the purpose of providing an electromagnetic interference (EMI) shield for an electronic device.

The metal layer can be made from a variety of materials. Preferred metals include elemental silver, gold, copper, nickel and chrome, with silver being especially preferred. Alloys such as stainless steel or dispersions containing these metals in admixture with one another or with other metals also can be employed. When additional metal layers are employed, they can be the same as or different from one another, and need not have the same thickness. Preferably the metal layer or layers are sufficiently thick so as to remain continuous if elongated by more than 3% in an in-plane direction, and sufficiently thin so as to ensure that the film and articles employing the film will have the desired degree of EMI shielding and light transmission. Preferably the physical thickness (as opposed to the optical thickness) of the metal layer or layers is about 3 to about 50 nm, more preferably about 4 to about 15 nm. Typically the metal layer or layers are formed by deposition on the above-mentioned support using techniques employed in the film metallizing art such as sputtering (e.g., cathode or planar magnetron sputtering), evaporation (e.g., resistive or electron beam evaporation), chemical vapor deposition, plating and the like.

The smoothness and continuity of the first metal layer and its adhesion to the support preferably are enhanced by appropriate pretreatment of the support. A preferred pretreatment regimen involves electrical discharge pretreatment of the support in the presence of a reactive or non-reactive atmosphere (e.g., plasma, glow discharge, corona discharge, dielectric barrier discharge or atmospheric pressure discharge); chemical pretreatment; flame pretreatment; application of a nucleating layer such as the oxides and alloys; or application of an organic base coat layer.

Films suitable for use as an EMI shield are described for example in U.S. Pat. No. 7,351,479; incorporated herein by reference. In one embodiment, the EMI shield film comprises a Fabry-Perot interference stack atop a light-transmissive polymeric film, such as previously described. The stack includes a first visible light-transparent metal layer spaced from a second visible light-transparent metal layer (e.g. made of silver) by means of an organic visible light-transparent spacing layer (e.g. made of a crosslinked acrylate polymer). The thicknesses of the metal layers and spacing layer are chosen such that the metal layers are partially reflective and partially transmissive. The spacing layer has an optical thickness (defined as the physical thickness of layer times its in-plane index of refraction) to achieve the center of the desired pass band for transmitted light. Wavelengths of light within the pass band are mainly transmitted through the thin metal layers; whereas wavelengths above the pass band are mainly reflected by the thin metal layers or canceled due to destructive interference. The hardcoat or protective film prepared from such hardcoat is suitable for use with various articles such as optical displays and display panels.

The term “optical display”, or “display panel”, can refer to any conventional optical displays, including but not limited to multi-character multi-line displays such as liquid crystal displays (“LCDs”), plasma displays, front and rear projection displays, cathode ray tubes (“CRTs”), and signage, as well as single-character or binary displays such as light emitting diodes (“LEDs”), signal lamps, and switches. The exposed surface of such display panels may be referred to as a “lens.” The invention is particularly useful for displays having a viewing surface that is susceptible to being touched or contacted by ink pens, markers and other marking devices, wiping cloths, paper items and the like.

The protective coatings of the invention can be employed in a variety of portable and non-portable information display articles. These articles include PDAs, cell phones (including combination PDA/cell phones), LCD televisions (direct lit and edge lit), touch sensitive screens, wrist watches, car navigation systems, global positioning systems, depth finders, calculators, electronic books, CD and DVD players, projection television screens, computer monitors, notebook computer displays, instrument gauges, instrument panel covers, signage such as graphic displays and the like. The viewing surfaces can have any conventional size and shape and can be planar or non-planar, although flat panel displays are preferred. The coating composition or coated film, can be employed on a variety of other articles as well such as for example camera lenses, eyeglass lenses, binocular lenses, mirrors, retroreflective sheeting, automobile windows, building windows, train windows, boat windows, aircraft windows, vehicle headlamps and taillights, display cases, road pavement markers (e.g. raised) and pavement marking tapes, overhead projectors, stereo cabinet doors, stereo covers, watch covers, as well as optical and magneto-optical recording disks, and the like.

Various permanent and removable grade adhesive compositions may be coated on the opposite side (i.e. to the hardcoat) of the (e.g. protective film substrate) so the article can be easily mounted to a (e.g. display) surface. Suitable adhesive compositions include (e.g. hydrogenated) block copolymers such as those commercially available from Kraton Polymers of Westhollow, Tex. under the trade designation “Kraton G-1657”, as well as other (e.g. similar) thermoplastic rubbers. Other exemplary adhesives include acrylic-based, urethane-based, silicone-based, and epoxy-based adhesives. Preferred adhesives are of sufficient optical quality and light stability such that the adhesive does not yellow with time or upon weather exposure so as to degrade the viewing quality of the optical display. The adhesive can be applied using a variety of known coating techniques such as transfer coating, knife coating, spin coating, die coating and the like. Exemplary adhesives are described in U.S. Patent Application Publication No. 2003/0012936. Several of such adhesives are commercially available from 3M Company, St. Paul, Minn. under the trade designations 8141, 8142, and 8161.

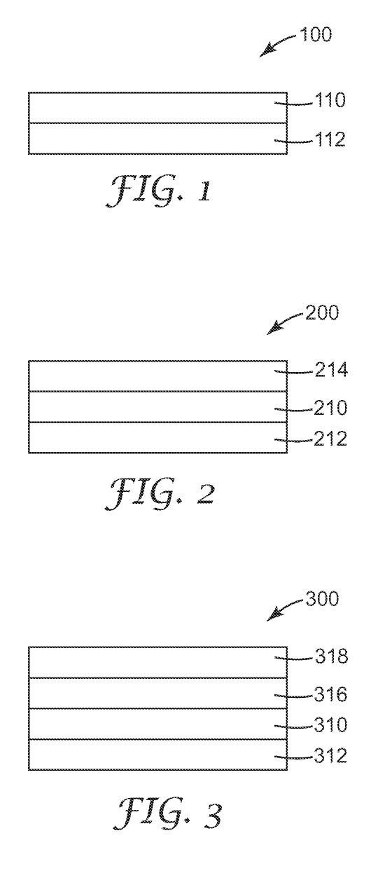

FIG. 1 depicts a hardcoat film article of the invention. Hardcoat film article 100 includes cured hardcoat layer 110 disposed on release liner 112. A hardcoat solution can be coated onto release liner 112 using coating methods known in the art. The thickness of cured hardcoat layer 110 can be any useful thickness. In some embodiments, cured hardcoat layer 110 has a thickness in a range from about 1 to about 25 micrometers (preferably, about 1 to about 15; more preferably, about 1 to about 10; even more preferably, about 1 to about 5 micrometers).

The hardcoat film articles of the invention can further comprise a (e.g. thermoplastic) light transmissive film layer. As illustrated in FIG. 2, hardcoat film article 200 comprises (e.g. thermoplastic) light transmissive film layer 214 disposed on cured hardcoat layer 210. The thickness of (e.g. thermoplastic) light transmissive film layer 214 can be any useful thickness. In some embodiments, thermoplastic layer 214 has a thickness of about 0.5 to about 20 micrometers (preferably, about 0.5 to about 5; more preferably, about 0.5 to about 3; even more preferably, 1 to about 3 micrometers).

In some embodiments, cured hardcoat layer 210 and (e.g. thermoplastic) light transmissive film layer 214 have a combined film thickness of about 1.5 to about 25 micrometers (preferably, about 1.5 to about 15; more preferably, about 1.5 to about 10 micrometers).

Surface treatments can sometimes be useful to secure adhesion between (e.g. thermoplastic) light transmissive film layer 214 and the cured hardcoat layer 210. Surface treatments include, for example, chemical priming, corona treatment, plasma or flame treatment. A chemical primer layer or a corona treatment layer can be disposed between layer 214 and cured hardcoat layer 210.

Suitable chemical primer layers can be selected from urethanes, silicones, epoxy resins, vinyl acetate resins, ethyleneimines, and the like. Examples of chemical primers for vinyl and polyethylene terephthalate films include crosslinked acrylic ester/acrylic acid copolymers disclosed in U.S. Pat. No. 3,578,622. The thickness of the chemical primer layer is suitably within the range of about 10 to about 3,000 nanometers.

The hardcoat film articles of the invention can be used to protect a substrate. In some embodiments, an adhesive (for example, a pressure sensitive adhesive) can be used to adhere the hardcoat film article to the substrate that is to be protected. The adhesive can be disposed on the substrate.

Alternatively, the adhesive can be disposed on at least a portion of the cured hardcoat layer, as illustrated in FIG. 3. Hardcoat film article 300 includes cured hardcoat layer 310 disposed on release liner 312 and adhesive layer 316 (and an optional second release liner 318) disposed on cured hardcoat layer 310. Optional second release liner 318 can be removed to reveal adhesive layer 316 so that adhesive layer 316 can be used to adhere hardcoat film article 300 to a substrate. Once hardcoat film article 300 is adhered to a substrate, release liner 312 can be removed.

The protective film articles described herein are suitable for methods of making an article that comprise lining a mold cavity with the protective film; injecting a solidifiable resin composition into the mold cavity; solidifying the resin composition; and removing the solidified resin article comprising the protective film from the mold.

In one embodiment, the (e.g. thermoplastic) light transmissive film layer (e.g. of FIG. 2) is placed within a metal or ceramic mold cavity such that the cured hard coat surface is in contact with the mold. The flexible hardcoat described herein is particularly advantageous for embodiments wherein the mold has a curved surface (e.g. having a radius of curvature of at least about 1 mm). A solidifiable resin such as a molten thermoplastic resin or curable polymerizable (e.g. urethane) resin is then injected into the cavity of the mold so that an integrated body of the protective film and molded article is obtained.

Objects and advantages of this invention are further illustrated by the following examples, but the particular materials and amounts thereof recited in these examples, as well as other conditions and details, should not be construed to unduly limit this invention.

### EXAMPLES

### Trade Designation (Chemical Description, Supplier)

Ebecryl 8301 (aliphatic urethane hexaacrylate, Cytec Inc.)
Ebecryl 284N (aliphatic urethane diacrylate blended with 12 wt-% 1,6 hexanediol diacrylate, Cytec Inc.)
SR444c (pentaerythritol triacrylate, Sartomer Company, Inc.)
CN-981B88 (aliphatic polyester/polyether based urethane diacrylate oligomers, Sartomer Company, Inc.)

### Tinuvin 928 (UVA—Ciba Chemical Corporation, Tarrytown N.Y.)

### Irgacure 819 (PI—Ciba Chemical Corporation, Tarrytown N.Y.)

### Tinuvin 123 (HALS—Ciba Chemical Corporation, Tarrytown N.Y.)

### Preparation of Silica Nanoparticle Dispersion

A 2000 ml 3-neck flask equipped with an addition funnel, temperature controller, paddle stirrer, heating mantle and distilling head was charged with 500 g of Nalco 2327 colloidal silica. To this dispersion, 500 g 1-methoxy-2-propanol (Alfa Aesar Stock #41457, 99+%) was added with stirring. Next 26.2 g 3-(methacryloyloxy)propyltrimethoxysilane (Alfa Aesar Stock # A17714, 97%) and 250 g 1-methoxy-2-propanol was added to the flask. The batch was heated to 80 deg C. and held for approximately 16 hours with stirring. The resulting mixture was a translucent, nearly clear dispersion. The batch was cooled to room temperature and transferred to a 2000 ml 1-neck flask. The batch was then vacuum-distilled on a Rotovap to approximately 85% solids. Finally, 235 g of methyl ethyl ketone (EMD Chemicals, Stock #BX1673-1) was added to dilute the system to 40.5 wt % solids, nearly clear dispersion.

### Preparation of DES N100/0.95 PET3A/0.10 HFPO—C(O)NHCH₂CH₂OH(HFPO Urethane 1)

HFPO—C(O)N(H)CH₂CH₂OH of molecular weight 1344 was made by a procedure similar to that described in U.S. Publication No. 2004-0077775, entitled “Fluorochemical Composition Comprising a Fluorinated Polymer and Treatment of a Fibrous Substrate Therewith,” filed on May 24, 2002, for Synthesis of HFPO-oligomer alcohols with the exception that HFPO methyl ester F(CF(CF₃)CF₂O)aCF(CF₃)C(O)CH₃ with a=6.2 was replaced with F(CF(CF₃)CF₂O)aCF(CF₃)C(O)OCH₃ wherein a=6.67. The methyl ester material for preparation of the alcohol can be prepared according to the method reported in U.S. Pat. No. 3,250,808 (Moore et al.), the disclosure of which is incorporated herein by reference, with purification by fractional distillation.

Polyisocyanate was obtained from Bayer Polymers LLC, of Pittsburgh, Pa. under the trade designation “Desmodur™ N100”. (“Des N100”)

2,6-di-t-butyl-4-methylphenol (BHT), dodecanol, octadecanol, H2N(CH2)6OH, and dibutyltin dilaurate (DBTDL) are available from Sigma Aldrich of Milwaukee, Wis.

Pentaerythritol triacrylate (“PET3A”), under the trade designation “SR444C”, was obtained from Sartomer Company of Exton, Pa.

Dibutyltin dilaurate was obtained from (DBTDL) (Sigma-Aldrich)

Methyl ethyl ketone (MEK) was obtained from (EMD Chemicals, Gibbstown, New Jersey)

A 500 mL roundbottom equipped with magnetic stirbar was charged with 25.0 g (0.131 eq, 191 EW) DES N100, and 128.43 g methyl ethyl ketone. The reaction was swirled to dissolve all the reactants, the flask was placed in an oil bath at 55° C., and fitted with a adapter under dry air. Next, 0.10 g of a 10% by weight solids solution in MEK of dibutyltin dilaurate was added to the reaction. Via addition funnel, 17.59 g (0.0131 eq, 1344 EW) HFPO—C(O)N(H)CH₂CH₂OH was added to the reaction over about 20 min. The funnel was rinsed with ˜15 g of MEK. Two hours after the addition was complete, 0.52 g of BHT was added directly into the reaction, followed by dispensing 61.46 g (0.1243 eq, 494.3 EW) of Sartomer SR444C from a beaker. The beaker was then rinsed with ˜30 g of MEK. The reaction was monitored by FTIR and showed no peak due to an —NCO functional group at 2265 cm⁻¹ after 20 h of additional reaction. The reaction flask and contents were weighed, and the reaction was then adjusted to 30% solids by addition of 2.23 g of MEK to provide a clear light yellow solution.

### Preparation of Hardcoat Coating Solutions

Hardcoat solutions were prepared by combining the urethane (meth)acrylate, multifunctional (meth)acrylate crosslinker, an optional nanosilica dispersion as set forth in Table 1 as follows. To each hardcoat coating solution was added 1.5 wt-% Tinuvin 928, 1.0 wt-% Irgacure 819, and 0.5 wt-% Tinuvin™ 123. The solutions were diluted the methyl ethyl ketone (MEK) to make a 50 wt-% solids solution. The components were thoroughly admixed and heated for about 60 minutes at ambient temperature until all the components were in solution.

TABLE 1

| | Urethane | | | | | |
|---|---|---|---|---|---|---|
| Formulation | Oligomer | wt-% | Crosslinker | wt-% | Silica | wt-% |
| Comp. | Ebecryl | 28.9 | Ebecryl | 68.1 | None | 0 |
| HC 1 | 284N | | 8301 | | | |
| HC 2 | CN981B88 | 67.9 | SR 444c | 29.1 | None | 0 |
| HC 3 | CN981B88 | 48.5 | SR 444c | 48.5 | | 0 |
| HC 4 | CN981B88 | 29.2 | SR 444c | 67.8 | None | 0 |
| HC 5 | CN981B88 | 59 | SR 444c | 15 | A174 | 23 |
| HC 6 | CN981B88 | 52 | SR 444c | 36 | A174 | 9 |
| HC 7 | CN 9001 | 58.2 | SR 444c | 38.8 | None | 0 |
| HC 8 | CN981B88 | 23.2 | SR 444c | 54 | A174 | 19.8 |
| Comp. | CN 991 | 58.2 | SR 368 | 38.8 | None | 0 |
| HC 9 | | | | | | |
| HC10* | CN981B88 | 45 | SR 444c | 30 | A174 | 21.5 |

*HC10 also included 0.5 wt-% pph of HFPO Urethane 1.

### Preparation of Hardcoat Protective Film

A hardcoat protective film article was prepared by coating the hardcoat coating composition of Table 1 onto either polycarbonate film (5 mils thick, from Bayer under the trade designation “DE 1-1 PC”) or a (130 μm thick) multilayer reflective polarizing optical film commercially available from 3M Company, St. Paul under the trade designation “3M™Vikuiti™Dual Brightness Enhancement Film” by using a #6 wire wound bar (R.D.S., Webster, N.Y.). The coated film was cured using a high-pressure mercury lamp (H type) manufactured by Fusion Systems Corporation with ultraviolet (UV) radiation under conditions of 20 ft/min and 80% power to give a cured hardcoat having a thickness of about 5 microns on the optical film.

### Test Methods

### 1. Sand Abrasion Test

The hardcoat protective films were subjected to an oscillating sand test (ASTM F 735 using a rotary oscillatory shaker made by VWR) where the test conditions were 50 grams of sand, 400 rpm for 60 minutes. The equipment used for this test was a linear oscillating shaker manufactured by Arther H Thomas Co. Philadelphia, Pa. It is typically easy to detect scratching of the hardcoat by visually inspecting the samples after testing. In order to quantify the abrasion resistance, the percent of haze in the coated film can be measured and compared before and after testing. Haze was measured with a haze-gard plus manufactured by BYK Gardner.

### 2. Steel Wool Abrasion Test

The abrasion resistance of the cured films was tested cross-web to the coating direction by use of a mechanical device capable of oscillating steel wool fastened to a stylus (by means of a rubber gasket) across the film's surface. The stylus oscillated over a 10 cm wide sweep width at a rate of 3.5 wipes/second wherein a “wipe” is defined as a single travel of 10 cm. The stylus had a flat, cylindrical geometry with a diameter of 1.25 inch (3.2 cm). The device was equipped with a platform on which weights were placed to increase the force exerted by the stylus normal to the film's surface. The steel wool was obtained from Hut Products, Fulton, Mo. (1.25 in steel wool pad) under the trade designation “#0000-Super-Fine”. A single sample was tested for each example, with the weight in grams applied to the stylus and the number of wipes employed during testing reported.

### 3. Moldability

Three dimensional pieces were vacuum-molded as follows: the hardcoat protective film was placed into a heated (160 F) ceramic mold such that the hardcoat surface was in contact with the mold and vacuum was applied to hold the film in the cavity of the die. A 2 part urethane resin (commercially available from BondPak Adhesives under the trade designation “DG 1000”) was injected manually onto the film-covered mold and then a release liner was immediately rolled over the exposed surface of the cured urethane. The resin was allowed to cure for 15 minutes. This resulted in an encapsulated three-dimensional piece. Then the piece was removed from the ceramic mold and inspected for cracking.

### 4. Mandrel Test

The hardcoat protective films were evaluated for conformabilty by bending the film around a cylindrical tube or mandrel (the Elcometer 1506 cylindrical mandrel bend tester with multiple mandrel sizes). The surface was inspected for cracking. The diameter of the mandrel (in mm) was decreased until the first sign of cracking were observed.

5. Contact Angle—The cured hardcoat was rinsed for 1 minute by hand agitation in IPA before being subjected to measurement of water and hexadecane contact angles. Measurements were made using as-received reagent-grade hexadecane (Aldrich) and deionized water filtered through a filtration system obtained from Millipore Corporation (Billerica, Mass.), on a video contact angle analyzer available as product number VCA-2500XE from AST Products (Billerica, Mass.). Reported values are the averages of measurements on at least three drops measured on the right and the left sides of the drops. Drop volumes were 5 μL for static measurements and 1-3 μL for advancing and receding.

### Test Results

The test results for the hardcoat protective film on polycarbonate are reported in Table 2 as follows.

TABLE 2

| | Steel Wool | | | Sand Abrasion Results | | |
|---|---|---|---|---|---|---|
| | Wt | | Mandrel Test | Initial | | Haze |
| | (g) | # wipes | (mm dia) | Haze | Final Haze | Change |
| HC1 | 400 | 25 | #3 | 0.49 | 4.93 | 4.44 |
| HC2 | 400 | 25 | <#2 | 0.46 | 6.91 | 6.45 |
| HC3 | 400 | 25 | <#2 | 0.53 | 4.58 | 4.05 |
| HC4 | 1000 | 25 | <#2 | 1.08 | 6.24 | 5.16 |
| HC5 | 400 | 25 | <#2 | 0.8 | 5.35 | 4.55 |
| HC6 | 1000 | 25 | <#2 | 0.65 | 5.69 | 5.04 |
| HC7 | 400 | 25 | <#2 | 0.49 | 5.43 | 4.94 |
| HC8 | 1000 | 100 | #3 | 0.60 | 4.51 | 3.91 |
| HC9 | 400 | 25 | — | | | |
| HC | 400 | 25 | <=2 | 0.68 | 2.95 | 2.27 |
| 10 | | | | | | |

The moldability test results for the hardcoat protective film on DBEF are reported in Table 3 as follows.

| | Moldability |
|---|---|
| | Appearance (cracks) |
| HC1 | Yes |
| HC2 | No |
| HC3 | No |
| HC4 | No |
| HC5 | — |
| HC6 | No |
| HC7 | No |
| HC8 | Yes |
| HC9 | No |
| HC 10 | — |

The contact angle of HC10 was determined to be 102.4 degrees. The inclusion of the perfluoropolyether urethane additive is not expected to affect the flexibility, durability, or moldability properties.

What is claimed is:

1. A protective film comprising:
a cured hardcoat comprising the reaction product of a polymerizable composition comprising
one or more urethane (meth)acrylate oligomers;
at least one monomer comprising at least three (meth)acrylate groups; and
optionally inorganic nanoparticles;
wherein the cured hardcoat composition is sufficiently flexible such that a 5 micron film can be bent around a 2 mm mandrel without cracking.

2. The protective film of claim 1 wherein the urethane (meth)acrylate oligomer(s) are a di-(meth)acrylate oligomer(s).

3. The protective film of claim 1 wherein a homopolymer of the urethane (meth)acrylate oligomer(s) has an elongation of at least 20%.

4. The protective film of claim 3 wherein the homopolymer of the urethane (meth)acrylate oligomer(s) has a tensile strength of at least 1,000 psi.

5. The protective film of claim 1 wherein the cured hardcoat is sufficiently durable such that the hardcoat exhibits a change in haze of less than 10% after the oscillating sand abrasion testing.

6. The protective film of claim 1 wherein the polymerizable composition comprises less than 40 wt-% of crosslinkers comprising more than four (meth)acrylate groups.

7. The protective film of claim 1 wherein the polymerizable composition comprises less than 20 wt-% of crosslinkers comprising more than four (meth)acrylate groups.

8. The protective film of claim 1 wherein the polymerizable composition is substantially free of crosslinkers comprising more than four (meth)acrylate groups.

9. The protective film of claim 1 wherein the one or more urethane (meth)acrylates are aliphatic.

10. The protective film of claim 1 wherein the polymerizable composition comprises at least one fluorine-containing or silicone-containing component.

11. The protective film of claim 10 wherein the fluorine-containing or silicone-containing component is copolymerizable.

12. The protective film of claim 11 wherein the polymerizable composition comprises an HFPO-urethane additive.

13. The protective film of claim 1 wherein the hardcoat composition comprises 0 wt-% to 30 wt-% inorganic nanoparticles.

14. The protective film of claim 13 wherein the inorganic nanoparticles comprise silica.

15. The protective film of claim 1 wherein the cured hardcoat composition is disposed on a light transmissive polymeric film substrate.

16. The protective film of claim 15 wherein the light transmissive film substrate is thermoplastic.

17. The protective film of claim 16 wherein the film substrate is selected from the group consisting of polycarbonate, polyethylene terephthalate, polyethylene naphthalate, and cellulose acetate.

18. The protective film of claim 15 wherein the film substrate is a reflective multi-layer optical film.

19. The protective film of claim 15 wherein the substrate further comprise a metal or organometallic layer.

20. The protective film of claim 1 wherein the light transmissive substrate further comprises an adhesive on a surface opposing the cured hardcoat.

21. The protective film of claim 1 wherein the cured hardcoat composition is disposed on a release liner.

22. The protective film of claim 1 wherein the protective film in an antireflective film having a high refractive index layer disposed on the hardcoat and a low refractive index layer is disposed on the high refractive index layer.

23. An article having a curved surface wherein the article comprises the protective film of claim 1.

24. A method of making an article comprising:
lining a surface of a mold cavity with a protective film according to any of the preceding claims;
injecting a solidifiable resin composition into the mold cavity;
solidifying the resin composition; and
removing the solidified resin article comprising the protective film from the mold.

25. The method of claim 24 wherein the protective film comprises the cured hardcoat composition disposed on a light transmissive thermoplastic film substrate.

26. The method of claim 24 wherein at least a portion of the surface of the lined mold cavity has a curved surface.

27. The method of claim 24 wherein the solidifiable resin is a molten thermoplastic resin.

28. The method of claim 24 wherein the solidifiable resin is a polymerizable resin.

29. The method of claim 28 wherein the polymerizable resin in a urethane polymerizable resin.

30. A hardcoat coating composition comprising
one or more urethane di-(meth)acrylate oligomers;
at least one monomer comprising at least three (meth)acrylate groups; and
optionally inorganic nanoparticles;
wherein the composition comprises less than 40 wt-% of crosslinkers comprising more that four (meth)acrylate groups.

31. The hardcoat coating composition of claim 30 wherein the polymerizable composition comprises less than 20 wt-% of crosslinkers comprising more that four (meth)acrylate groups.

32. The hardcoat coating composition of claim 30 wherein the polymerizable composition is substantially free of crosslinkers comprising more that four (meth)acrylate groups.

33. The hardcoat coating composition of claim 30 wherein the urethane (meth)acrylate oligomer(s) are a di-(meth)acrylate oligomer(s).

34. The hardcoat coating composition of claim 30 wherein a homopolymer of the urethane (meth)acrylate oligomer(s) has an elongation of at least 20%.

35. The hardcoat coating composition of claim 30 wherein the homopolymer of the urethane (meth)acrylate oligomer(s) has a tensile strength of at least 1,000 psi.
